(19) United States
(12) Patent Application Publication
(10) Pub. No.: US 2025/0135686 A1
(43) Pub. Date: May 1, 2025

(54) SYSTEM AND METHOD OF CONVERTING PLASTIC WASTE TO USABLE PRODUCTS BY MINING LANDFILLS AND PROCESSING MUNICIPAL SOLID WASTE

(71) Applicant: Exotex, Inc., Houston, TX (US)

(72) Inventor: Michael J. Parrella, Katy, TX (US)

(21) Appl. No.: 18/833,485

(22) PCT Filed: Jan. 26, 2023
(86) PCT No.: PCT/US2023/011601

§ 371 Date: Jul. 26, 2024

Related U.S. Application Data
(63) Continuation of application No. PCT/US2022/081436, filed on Dec. 13, 2022.
(63) Continuation of application No. PCT/US2023/010573, filed on Jan. 11, 2023.
(60) Provisional application No. 63/303,310, filed on Jan. 26, 2022.

(51) Int. Cl. B29B 17/02; B29B 17/04; B29C 43/00; B29C 43/52; B29L 31/10; C08J 11/06; F02C 3/00; F02C 6/18; F23G 5/46

(52) U.S. Cl. CPC B29B 17/02; B29B 17/0412; B29C 43/003; B29C 43/52; C08J 11/06; F02C 3/00; F02C 6/18; F23G 5/46; B29L 2031/102; F05D 2220/76; F23G 2201/60; F23G 2206/20

(57) ABSTRACT

A system and method are provided for converting solid waste into new plastic products by utilizing the plastic from a landfill in new products and the fuel resources in the landfill in the manufacturing process. Biomass waste is combusted by a combustion system to generate residual heat and heated exhaust, and the residual heat and heated exhaust is used to fuel the manufacturing of new plastic products from the recovered plastic waste. Methane gas recovered from the landfill can also be used as a fuel source for heating manufacturing machinery and generating electricity used in the manufacturing processes.

### CROSS-REFERENCE TO RELATED APPLICATIONS

The present application claims the benefit of U.S. Provisional Patent Application 63/303,310 filed on Jan. 26, 2022, which is hereby incorporated by reference in its entirety, and further claims the benefit of International Patent Application PCT/US22/81436 filed Dec. 13, 2022, which is hereby incorporated by reference in its entirety, and further claims the benefit of International Patent Application Number PCT/US23/10573 filed Jan. 11, 2023, which is hereby incorporated by reference in its entirety.

### BACKGROUND OF THE DISCLOSURE

The past fifty years have seen a significant growth in the amount of municipal solid waste that has been generated. The vast majority of this municipal solid waste, including plastics, ends up deposited in landfills. Plastic waste poses many problems, including that it takes an exceptional amount of time to decompose, and much of the plastic that is intended to be recycled does not in fact get recycled.

The challenges posed by plastics in waste are exacerbated because plastics are one of the largest categories of waste products found in municipal solid waste, among other types of waste such as paper, food, and yard trimmings. Plastic waste, particularly near coastlines, results in millions of tons of plastic being input into the oceans each year. Once in the water, plastic and microplastic ingestion, entanglement, and interaction cause significant harm to marine life. Plastics deposited in landfills also are problematic because of their low degradability and difficulty in recycling, and incinerating plastic waste to dispose of it can release harmful chemicals.

The present application seeks to address these issues by providing methods and systems for taking plastics from municipal solid waste and providing an alternative usefulness to the plastics.

### SUMMARY OF THE DISCLOSURE

The present application relates to methods and systems to convert plastic waste to plastic long-term products by mining landfills and processing municipal solid waste. The present application seeks to: create long-term plastic products using waste plastics and waste heat from a waste to energy process; eliminate plastic ocean contamination; eliminate plastics in landfills; create long-term use plastic products; and create plastic building products that reduce cost of materials, replace cement and wood materials, reduce labor costs with special designs, increase construction speed, create affordable plastic housing kits (>75% plastic) and create upscale plastic housing kits (>75% plastic).

In accordance a first aspect of the present application, a method is provided, comprising providing recovered plastic waste from a waste repository; combusting biomass waste by a combustion system to generate residual heat and heated exhaust, and using the residual heat and heated exhaust in manufacturing new plastic products from the recovered plastic waste. In embodiments of the method, the waste repository is a landfill, and where the method further may include sorting waste recovered from the landfill into the recovered plastic waste, the biomass waste, and metals, where the biomass waste recovered from the landfill is provided to the combustion system.

The method may further include: providing recovered plastic waste to a pre-manufacturing processing stage, the pre-manufacturing processing stage comprising one or more of: sorting the recovered plastic waste and removing items of plastic waste not to be used in the new plastic products; decontaminating the recovered plastic waste; and/or cutting the recovered plastic waste; and outputting processed plastic waste to a plastic product manufacturing stage.

The plastic product manufacturing stage may include: combusting the biomass waste by the combustion system to generate the residual heat and heated exhaust; using the residual heat and heated exhaust to melt the processed plastic waste or the recovered plastic waste to generate melted plastic; and providing the melted plastic to a mold to shape and form a new plastic product. The plastic product manufacturing stage may additionally or alternatively include: combusting the biomass waste by the combustion system to generate the residual heat and heated exhaust; providing the processed plastic waste or the recovered plastic waste to a mold configured to melt plastic to shape and form a new plastic product; and using the residual heat and heated exhaust by the mold in forming the new plastic product. The plastic product manufacturing stage may include: combusting the biomass waste by the combustion system to generate the residual heat and heated exhaust; providing the processed plastic waste or the recovered plastic waste to a press configured to fuse plastic to shape and form a new plastic product; and using the residual heat and heated exhaust by the press in forming the new plastic product.

In accordance with any of the aforementioned embodiments of the method of the first aspect of the application, the method may further comprise: providing at least a portion of the residual heat and heated exhaust from the combustion system to an electricity generating system may include electric turbines; generating electricity by the electric turbines using the residual heat and heated exhaust from the combustion system; supplying the electricity to the plastic product manufacturing stage; and outputting turbine exhaust and turbine heat to the plastic product manufacturing stage for use therein. The method may additionally or alternatively comprise recovering methane from the waste repository; providing the methane to a second combustion system configured to burn methane to generate additional residual heat and additional heated exhaust; and outputting the additional residual heat and additional heated exhaust to the plastic product manufacturing stage for use therein. The method may additionally or alternatively comprise: recovering methane from the waste repository; providing the methane to an electricity generating system configured to burn methane to power turbines to generate electricity, additional residual heat and additional heated exhaust; and outputting the electricity, additional residual heat and additional heated exhaust to the plastic product manufacturing stage for use therein.

The new plastic products formed by the method may include construction products, including blocks having male locking members on a first surface, and female locking members on an opposing surface, the male locking members configured to engage the female locking members to allow blocks to be stacked.

In accordance with a second aspect of the present application, a system is provided, comprising: a waste repository comprising plastic waste and biomass waste and a sorting station configured for sorting recovered plastic waste and recovered biomass waste from other waste in the waste repository; a combustion system configured to combust separated biomass waste to generate residual heat and heated exhaust, and a plastic product manufacturing system configured to use the residual heat and heated exhaust in manufacturing new plastic products from recovered plastic waste from the waste repository.

The system may further comprise: a pre-manufacturing processing system, the pre-manufacturing processing system configured to perform one or more of sorting the recovered plastic waste and removing items of plastic waste not to be used in the new plastic products, decontaminating the recovered plastic waste, and/or cutting the recovered plastic waste; and the pre-manufacturing processing system being further configured to output processed plastic waste to a plastic product manufacturing stage.

In accordance with embodiments of the system of the second aspect of the application, the plastic product manufacturing system may include: the combustion system configured to combust the biomass waste and to generate the residual heat and heated exhaust; a plastic melting device configured to use the residual heat and heated exhaust to melt the processed plastic waste or the recovered plastic waste to generate melted plastic; and a mold configured to shape and form the melted plastic into a new plastic product. The plastic product manufacturing system may additionally or alternatively comprise: the combustion system configured to combust the biomass waste and to generate the residual heat and heated exhaust; a mold configured to melt the processed plastic waste or the recovered plastic waste to shape and form a new plastic product using the residual heat and heated exhaust in forming the new plastic product.

The system of the second aspect of the application may further comprise an electricity generating system including electric turbines configured to: receive at least a portion of the residual heat and heated exhaust from the combustion system; generate electricity by the electric turbines using the residual heat and heated exhaust from the combustion system; supply the electricity to the plastic product manufacturing system; and output turbine exhaust and turbine heat to the plastic product manufacturing system for use therein.

The system of the second aspect of the application may further comprise a second combustion system configured to burn methane recovered from the waste repository to generate additional residual heat and additional heated exhaust, and to output the additional residual heat and additional heated exhaust to the plastic product manufacturing system for use therein. The electricity generating system may be configured to receive at least a portion of the additional residual heat and additional heated exhaust from the second combustion system, generate electricity by the electric turbines using the additional residual heat and additional heated exhaust from the combustion system; supply the electricity to the plastic product manufacturing system; and output turbine exhaust and turbine heat to the plastic product manufacturing system for use therein.

### BRIEF DESCRIPTION OF THE DRAWINGS

FIG. 1 shows a comprehensive energy generation system, including an array of possible inputs and outputs depending on the particular implementation and use;

FIG. 2A shows a further comprehensive energy system according to the present application incorporating an oil and gas reservoir;

FIG. 2B shows a diagram of methane and waste processing flow from a landfill in accordance with an embodiment of the present application;

FIG. 3 shows a process for the conversion of plastic waste by mining landfills and processing municipal solid waste, and creating long-term plastic products that reduce ocean contamination and methane emissions using waste heat according to the present application; and

FIGS. 4A-4D shows an example of a plastic block created with a process according to the present application.

### DETAILED DESCRIPTION OF THE DRAWINGS

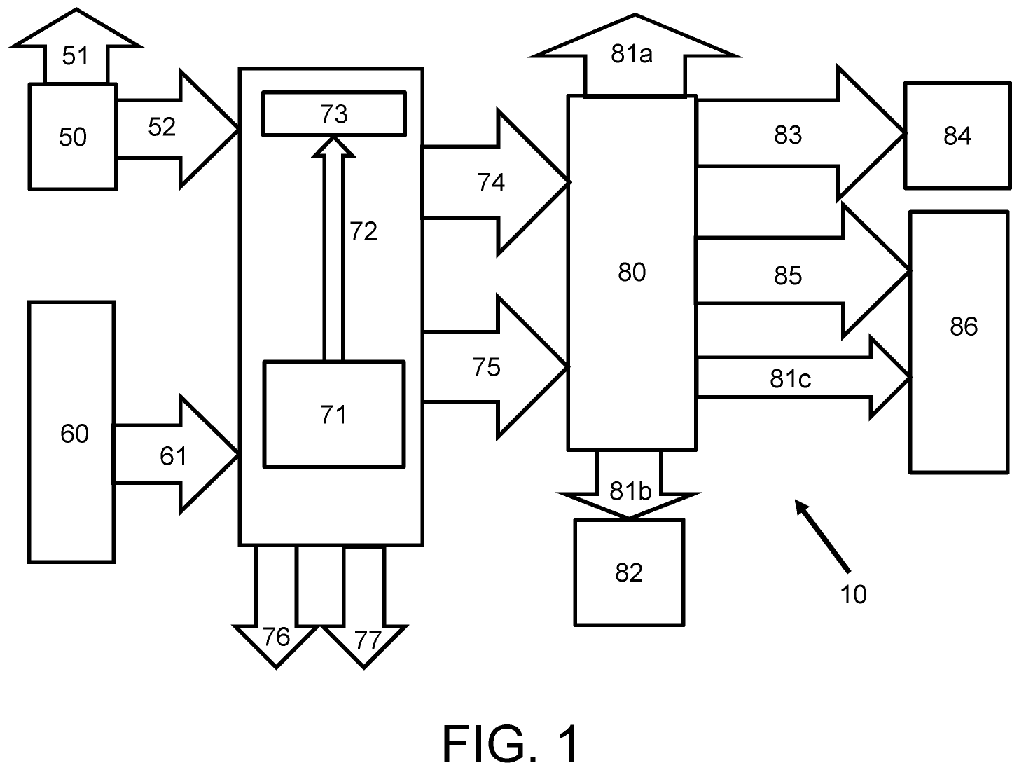

Subject matter of the present application will now be described with reference made to FIGS. 1-4D.

FIG. 1 shows an overview of one or more comprehensive energy generation systems 10, including an array of possible inputs and outputs depending on the particular implementation and use. A more detailed explanation of these systems can be found in International Patent Application PCT/US22/81436 filed Dec. 13, 2022.

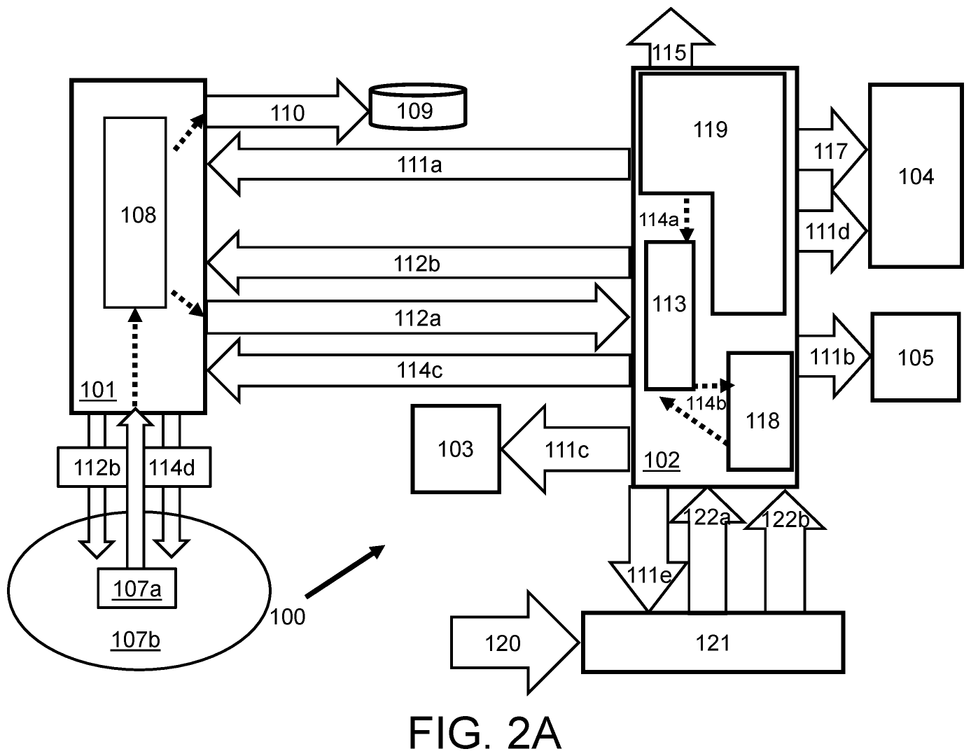

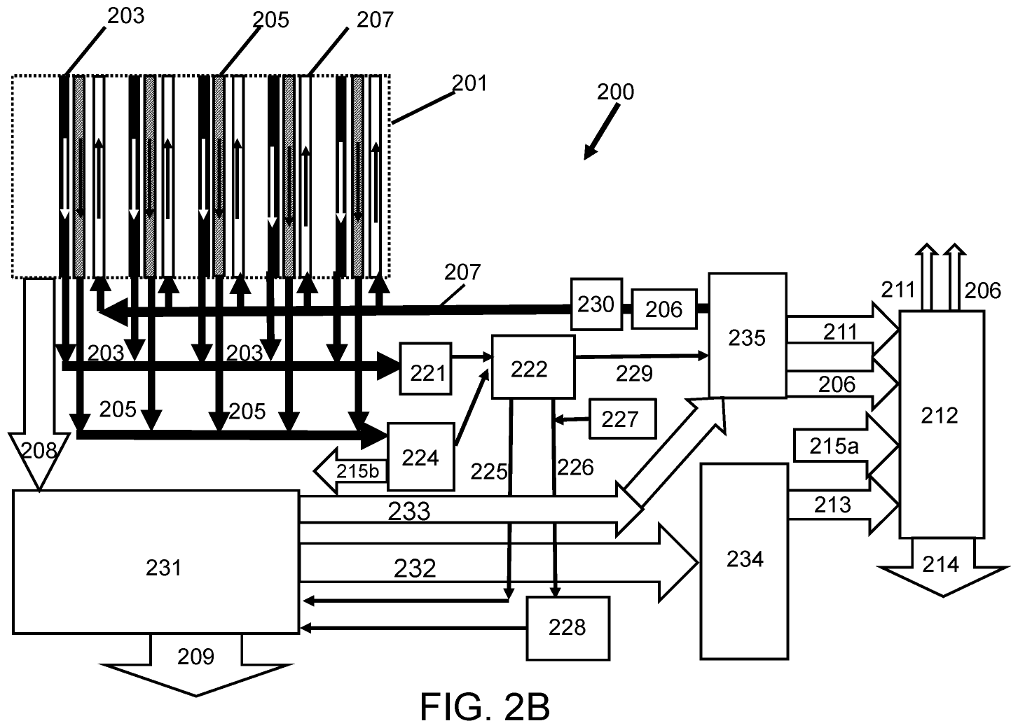

In a first aspect of the system 10, an oil and/or gas reservoir 50 is present, and oil 51 is extracted for the market and gas 52 extracted and provided to gas boilers 73. The gas boilers 73 create heat 74 and hot exhaust 75, which is provided to a steam turbine 80 for power generation. A more detailed explanation of the incorporation of an oil and/or gas reservoir in the energy recovery and utilization system is shown and provided in FIG. 2A.

In a second aspect of the system, a landfill 60 with municipal waste is provided, and the organic waste 61 is separated from metals and plastic, and provided to a furnace or burner 71 for waste to energy pyrolysis or gasification. The furnace or burner 71 can be used in the process of manufacturing cement 76 or plastic 77, such that the biomass waste 61 is used as a fuel source in the manufacturing process. Syngas 72 can be provided from the furnace or burner 71 to the gas boilers 73, and the furnace or burner 71 also generates heat 74 and hot exhaust 75. A more detailed explanation of the incorporation of a landfill or other waste receptacle in the energy recovery and utilization system is shown and provided in FIG. 2B. The system 10 can utilize either or both of natural gas 52 and organic waste 61 as a fuel to be burned for the provision of heat 74 and exhaust 75 to the turbine 80.

The turbine 80 generates electricity, including electricity 81a that can be provided to the electricity market, electricity 81b that can be provided to a data center 82 or another facility, and electricity 81c that can be provided to a crop growth system 86, such as a greenhouse. The power generation also includes the separation of exhaust gases into component parts for other uses, such as separating carbon dioxide 83 for sequestering in an oil and/or gas reservoir 84 (which may be the same as reservoir 50) and separating carbon dioxide and nitrogen 85 for providing to the crop growth system 86.

FIGS. 2A and 2B show systems such as those in FIG. 1 in greater detail, with FIG. 2A showing a system 100 that utilizes a hydrocarbon production system 101 in combination with waste 120, and FIG. 2B showing a system 200 that incorporates a landfill 201 and landfill gas and waste separation system.

In the comprehensive energy system 100 of FIG. 2A, the fuel utilized by an electricity generation system 102 includes waste 120 (i.e., biomass recovered from garbage) to provide a waste combustion system 121. Waste 120 may come from landfills, refuse, garbage, or trash systems, public or private. Prior to combustion, the waste 120 to remove metals and plastics, so that the waste 120 provided for combustion is only biomass. The waste combustion system 121 can include a burner, furnace or kiln that burns waste 120 and provides waste heat 122a and waste exhaust 122b to the electricity generation system 102, where the waste heat 122a and the waste exhaust 122b is used for electric generation by steam turbines 119 and for heating brine 112a by the heat exchanger 113. The waste combustion system 121 provides low electricity costs, net zero emissions with no carbon dioxide emissions and allows income from garbage disposal by converting the waste 120 to electricity generated by the electricity generation system 102. Electricity 111e generated by the steam turbines 119 can be supplied back to the waste combustion system 121 for powering the components thereof.

The comprehensive energy system 100 in FIG. 2 includes several elements, including a hydrocarbon production system 101 configured for recovery of oil and gas, comprising one or more production wells having submersible pumps (not shown) configured to pump oil, natural gas and/or brine 107a from a reservoir 107b, and one or more oscillators (not shown) that create pull pulses from the reservoir 107b, and which create low pressure in the reservoir 107b that creates flow to the production well of the hydrocarbon production system 101. The hydrocarbon production system 101 also comprises injection wells and heat delivery wells (not shown) configured to increase the productivity of the one or more production wells. Additionally, the hydrocarbon production system 101 comprises a separator 108 that separates the oil, natural gas, and brine 107a recovered from the reservoir 107b by the production wells. Separated oil 110 flows to an oil storage 109 or to another location for further use, or the electricity generation system 102 for the generation of clean electricity. If there is an excess of natural gas, it may be sold or used to generate electricity for sale.

An electricity generation system 102 is configured to generate electricity by way of electricity generating turbines 119. The turbines 119 are further configured to generate heat and exhaust that is processed by a heat exchanger 113 and a gas separator 118 for use by the comprehensive energy system 100. It is to be understood that while FIG. 2A shows the heat exchanger 113 and gas separator 118 as components of the electricity generation system 102, the heat exchanger 113 and gas separator 118 may be located separately or externally from the electricity generation system 102 and/or turbines 119.

Separated brine 112a can flow to the heat exchanger 113. The electric turbines 119 can be implemented in 5 MW (or larger) modules and are completely expandable, and may be steam or gas turbines. Some or all of the electricity 111a generated can then be used operate the components of comprehensive energy system 100, including the hydrocarbon production system 101 and electricity generation system 102, including the wells, pumps, heating elements, control devices, and any other electronic devices required therein. If more electricity is generated than is required by the comprehensive energy system 100, excess electricity 111c can be sold to a grid 103 or electricity 111b can be provided to external facilities 105 for further use by the facilities 105, such as data centers, wastewater treatment centers, green bulk hydrogen generation, and/or smart cities. If the amount of electricity to be generated by the electric turbines 119 requires more than the waste 120 supplied, extracted gas can be utilized, or an optional external gas supply or emulsified oil can be used.

The hot exhaust 114a from the electric turbines 119 can flow into the heat exchanger 113. The brine 112a from the separator 108 and the exhaust 114a from the electric turbine 119, which can be greater than 500° C., flows into the heat exchanger 113. The thermal energy from the exhaust 114a is transferred to the brine 112a in the heat exchanger 113, and the hot brine 112b flows to the injection wells and the heat delivery wells of the hydrocarbon production system 101.

A gas separator 118 for separating different gases in the exhaust gas 114a may also be provided. Cooled exhaust gas 114b, after transferring heat to the brine 112a, is provided from the heat exchanger 113 to the gas separator 118. Approximately 78% of air input to the gas separator 118 is nitrogen. Nitrogen 115 is separated from the exhaust 114b of the electric turbines 119 by the gas separator 118 and can be stored, sold or provided for other uses. Oxygen is also separated from the exhaust 114b and separated, highly concentrated oxygen can be fed back into the electric turbine 119 for injection into the electric turbine 119, or can be stored, sold or provided for other uses. The gas separator 118 also separates out carbon dioxide 114c from the exhaust 114b. The cooled carbon dioxide exhaust gas 114c from the gas separator 118 is injected by injection wells of the hydrocarbon recovery system 101 into the reservoir 107b and sequestered, creating a carbon dioxide flood to increase production from the reservoir 107b. The gas separator 118 is configured to separate carbon dioxide, oxygen, but output separated carbon dioxide 114c for sequestration 114d, and also output carbon dioxide with nitrogen 117 for external use. The carbon dioxide and nitrogen 117 can be delivered to greenhouses 104 and used for crop stimulation (carbon dioxide capture using photosynthesis), or may be delivered to other crop growing environments outside of a greenhouse. Crop stimulation can increase crop yield by 30-60%. Any separated carbon dioxide not used for crop stimulation may be sold or added to the carbon dioxide 114d that is sequestered underground. Electricity 111d generated by the electric turbines 119 is also supplied to the greenhouses 104 to meet electric needs of the greenhouses 104.

The hydrocarbon production system 101 comprises injection wells (not shown), which comprise a pump and oscillator for the brine 112b. The pump creates the necessary pressure, and the oscillator creates the pulses. Examples of such oscillators can be found and are described in applicant's International Application PCT/US22/45009, which is hereby incorporated by reference in its entirety. A compressor creates pressure for the injection of exhaust gases and carbon dioxide 114c into the reservoir 107b. Injectors create high pressure zones in the reservoir 107b that directionally mobilizes the hydrocarbons 107a to move toward the lower pressure zones created by the production wells. Heat wells pump hot brine 112b into the reservoir 107b, including at a 90-degree angle, to create low viscosity paths of least resistance. This allows the comprehensive energy system 100 to volumetrically extract hydrocarbons 107a, where the injection wells may be approximately five hundred twenty five feet from the production wells.

Further in the comprehensive energy system 100, municipal waste 120, and optionally other waste, is burned by the waste combustion system 121 to generate heat 122a used in generating steam for the steam turbines 119, as previously described. If gas is extracted from the reservoir 107b and is not sold, it can be used in burning the waste 120 by waste combustion system 121 to avoid flaring the gas. The waste heat 122a and hot exhaust 122b (including carbon dioxide exhaust) generated by the waste combustion system 121 are transferred to the electricity generation system 102 for processing, where they are used by the steam turbines 119 and in heating the brine 112a by the heat exchanger 113.

FIG. 2B shows a diagram of methane and waste processing system 200 in accordance with an embodiment of the present application. A more detailed explanation of these and related systems can be found in International Patent Application Number PCT/US23/10573 filed Jan. 11, 2023. A landfill 201 is provided with biogas collection wells 203 for the collection of biogas from the landfill 201, the biogas primarily comprising methane, leachate collection wells 205 for the collection of leachate 204 from the landfill 201, and carbon dioxide wells 207 for the injection of carbon dioxide 206 into the landfill 201.

A pump 221 draws biogas in the landfill 201 into the biogas collection wells 203, and pumps the biogas to a gas separator 222. The gas separator 222 separates out component gases of the collected biogas, include methane, oxygen, and carbon dioxide. The separated oxygen 225 and methane 226 are delivered to a combustion system 231 to generate steam 232 for electric turbines 234. The electric turbines 234 can be gas powered or steam powered, and supply the necessary electricity for the components of the system 200. The combustion system 231 comprises a boiler, burner, or furnace. The waste 208 is sorted and separated, and the metals and plastics 209 are removed. The remaining biomass waste 208 is burned to create steam 232. Any condensate is removed, and the hot exhaust 233 is also used in the generation of steam 232, and then delivered to another gas separator 235. For example, the heated exhaust 233 may transfer heat to a fluid such as water in the combustion system 231 to generate additional steam 232, and the cooled exhaust is supplied to the gas separator 235. Natural gas 227 can be used to supplement the flow of methane 226 from the landfill 201 if needed to support the combustion system 231. If the landfill 201 produces more methane than is required for the combustion system 231, the methane 226 may be stored in a methane storage 228. The exhaust and other gases 229 from the gas separator 222 are delivered to another gas separator 235.

In the system 200 of FIG. 2B, the leachate is provided to a sludge digester 224 receiving sludge from a wastewater treatment system (not shown), and the microbes of the leachate are used by the sludge digester 224. The sludge digester 224 digests the sludge and provides it to one or more belt presses configured to press out liquid remaining in the digested sludge or other drying device. The final processed and dried sludge can result in humus 215a, 215b that can be provided to greenhouses 212 for crop growth. Methane recovered from the sludge digester 224 can be provided to the gas separator 222.

The exhaust 233 from the burning of the methane and waste 208, and other gases 229 from the gas separator 222, are delivered to another gas separator 235. The gas separator 235 separates the carbon dioxide 206 from the supplied gases 229 and exhaust 233 and outputs the carbon dioxide 206 to a pump 230, which pumps the carbon dioxide into the injection wells 207 for the landfill 201. The gas separator 235 also separates the nitrogen 211 and delivers it to the greenhouses 212, along with additional carbon dioxide 206, and releases or processes the other gases. The greenhouses 212 use as much carbon dioxide 206 and nitrogen 211 as needed, and release oxygen 214. The excess carbon dioxide 210 and nitrogen 211 can be sold or released. The greenhouses are supplied with electricity 213 from the electric turbines 234.

If there are enough greenhouses 212, an effective negative net emissions of the greenhouse gas can be achieved because of the elimination of the methane. The total greenhouse gas emissions of the system are the carbon dioxide generated from burning waste, methane, and gas plus the carbon dioxide extracted or released from the landfill, less the carbon dioxide injected into landfill and the carbon dioxide used by greenhouses, and also less the methane recovered from the landfill (noting that methane can be 28 to 36 times more effective than carbon dioxide at trapping heat). The plastic 209 is used for products as described further herein.

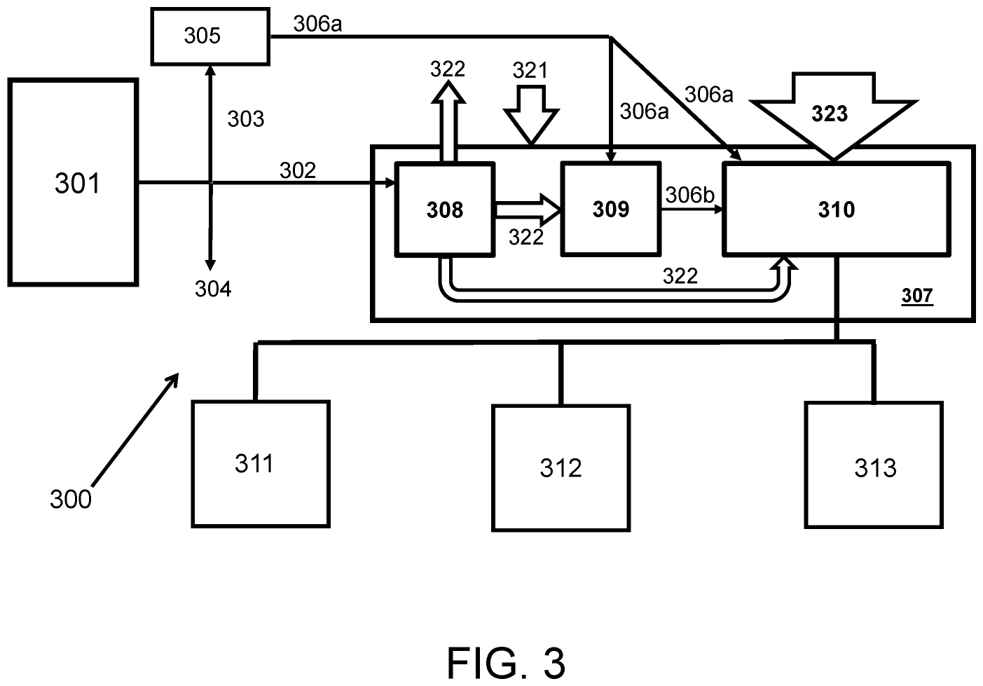

FIG. 3 illustrates a system and process 300 for the conversion of plastic waste by mining landfills and processing municipal solid waste, and creating long-term plastic products that reduce ocean contamination and methane emissions using waste heat. The plastic waste and waste heat can optionally be derived from systems such as those shown in FIGS. 1, 2A, and 2B.

The process may start with a landfill 301, or other solid waste repository, and the solid waste is sorted into biomass 302, plastics 303, and metals 304. The biomass 302 is supplied to a combustion system 308 to use as a fuel source. The metals 304 are recovered and can be sold or stored for other purposes not described herein. The plastics 303 recovered from the landfill 301 are recovered and processed to be incorporated into new products that may have a longer use life to avoid the plastics 303 being redeposited in another landfill.

The recovered plastics 303 can optionally be provided to a plastic processing stage 305 before being provided to a plastic product manufacturing stage 307. In the plastic processing stage 305, the recovered plastics 303 can be sorted to remove any items or plastics that cannot be reused in another product, cleaned or decontaminated, and/or chopped, cut or processed in a manner to make the plastics 303 easier to work with or form in the plastic product manufacturing stage 307. The plastic processing stage 305 can perform any one or more of these operations as needed. The processed plastic 306a is output from the plastic processing stage 305 and supplied to the plastic product manufacturing stage 307.

The plastic product manufacturing stage 307 comprises a combustion system 308, which can include a burner, furnace or kiln that burns the recovered biomass waste 302 and outputs residual heat and hot exhaust 322. The residual heat and hot exhaust 322 can be utilized by a melting device 309 that receives the processed plastics 306a to transfer heat the processed plastics 306a. The processed plastics 306a are melted and the melted plastic 306b provided to a product forming stage 310 including one or more product molds to shape the melted plastic 306b into usable products. Additionally or alternatively, the residual heat and hot exhaust 322 can be provided to the product forming stage 310 comprising molds, presses, and other structures and devices for shaping plastic products. The processed plastics 306a may also be provided directly to the product forming stage 310, which can form the products without a pre-melting of the processed plastics 306a by the melting device 309. The product forming stage 310 may melt the plastic 306a directly transferring heat from the residual heat and hot exhaust 322 in the molding of the products, or may fuse the processed plastics 306a together into a product form with the transfer of heat from the residual heat and hot exhaust 322, without fully melting the plastics 306a.

The product forming stage 310 may form any number of products from the recovered plastics 303, including but not limited to construction materials 311, including for example bricks, shingles, siding, boards, planks, tiles, flooring, sinks, bathtubs, and showers; commercial products 312 such as medical products or automotive parts; and consumer products 313 such as toys, kitchen products, packaging, and other plastic product.

The process 300 and plastic product manufacturing stage 307 are provided in combination with an electricity generating system not shown in FIG. 3, but similar to those shown in FIGS. 2A and 2B and described above. The electricity generating system comprises electric turbines, The which can be steam or gas turbines, and can be implemented in 5 MW (or smaller or larger) modules. Electricity 321 generated by the electricity generating system can be supplied to the plastic product manufacturing stage 307 to provide electricity where needed by the combustion system 308, melting device 309, and/or product forming stage 310. The residual heat and hot exhaust 322 can be output from the combustion system 308 to the electricity generating system and used by the electric turbines in the generation of electricity 321. This can be performed in the same manner as previously shown and described in FIG. 2A in reference to waste heat 122a and waste exhaust 122b with the electricity generation system 102, or as previously shown and described in FIG. 2B in reference to waste heat or steam 232 and waste exhaust 233 with the turbines 234. The hot exhaust and heat 323 from the electric turbines can also be provided to the plastic product manufacturing stage 307 and the thermal energy from the hot exhaust and heat 323 used for the formation of plastic products by the product forming stage 310, or in the melting of plastics 306a by the plastic melting device 309.

The process 300 of making plastic products from recovered plastic waste 303 can be further aided if needed by other combustion systems and fuel sources. For example, where the plastic waste 303 is recovered from a landfill 301, biogas comprising methane can also be recovered from the landfill 301 as previously discussed, and the methane used as a fuel source as shown in FIG. 2B. A combustion system, comprising a burner, boiler, or furnace burns methane from the biogas, a process which results in the creation of heat, exhaust, and carbon dioxide, which can be output to an electricity generation system, where the heat, exhaust, and carbon dioxide are used for electric generation by electric turbines. For example, the heat and heated exhaust may be used to heat a fluid to convert the fluid to steam to power the electric turbines. The methane recovered from the biogas can also be burned directly by electric turbines to generate electricity. The electricity 321 and the waste heat and exhaust 323 generated by these turbines can be provided to the plastic product manufacturing stage 307 to power its operations, as previously discussed. Alternatively, the methane can be burned by the combustion system 308 separately from or in lieu of the biomass 302, to provide residual heat and exhaust 322 used in the melting of plastic and/or formation of plastic products by the plastic product manufacturing stage 307. In total, the system and process 300 of FIG. 3 provide for the creation of new products while utilizing minimal new energy and resource inputs outside of the landfill 301 and reducing carbon dioxide and/or methane emissions.

Other fuel sources can be used as well, either for generating further thermal energy by a combustion system that are transferred directly to the product forming stage 310, or the plastic melting device 309, or for powering electric turbines as previously discussed, such as oil or gas recovered from a reservoir such as the reservoir 107b of FIG. 2A. Extracted natural gas (or products made by processing the extracted natural gas or recovered oil from reservoir) is burned by electric turbines to generate electricity, which can then be used operate the components of the plastic product manufacturing stage 307. The thermal energy from the turbine exhaust 323 can also be transferred to the plastic product manufacturing stage 307. Alternatively, a pre-existing combustion system at a facility comprising the plastic product manufacturing stage 307 but having a separate purpose can be used in combination with the combustion system 308, wherein the waste heat and/or exhaust from the combustion system would otherwise go unused.

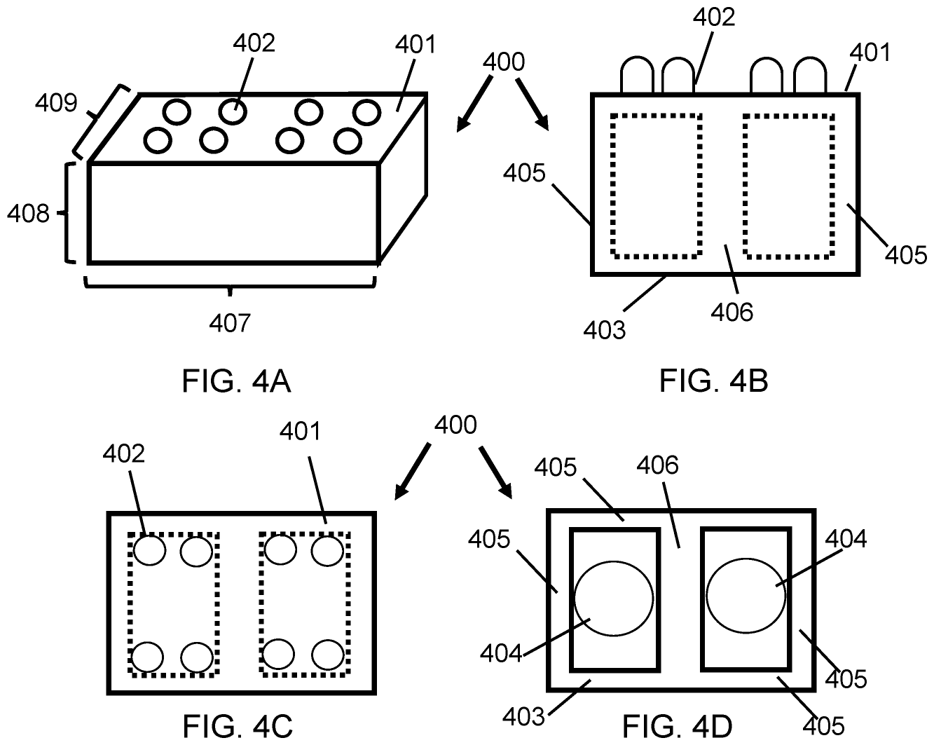

The present application provides for plastic blocks 400 that can be used for construction in place of standard concrete blocks, among other construction products 311, commercial products 312, and consumer products 313. A standard concrete block is 7.625 inches wide by 7.625 inches tall by 15.625 inches long. With a 0.375 inch masonry joint, which equates to 8-by-8-by-16 inches when the block is installed in a structure. To reduce weight, concrete blocks usually have two or three hollow cores taking up about 50 percent of the block's volume. An example of such a plastic block 400 is shown in FIGS. 4A-4D. The plastic block 400 may include male locking members 402 on a top surface 401 of the block 400, and female locking members 404 on the bottom 403 of the block 400. The male locking members 402 engage the female locking members 404 to allow blocks to be stacked, either one block 400 directly overlapping another block 400 beneath it, or partially overlapping another block 400. The male locking members 402 are formed by a plurality of projections from the top surface 401 of the block, that are configured to be received in or in between a plurality of openings forming the female locking members 404 on the bottom surface 403 of the block 400. The interlocking blocks 400 can reduce labor and material costs in the construction industry that would otherwise use cement blocks. The blocks shown in FIG. 4 can have a length 407 of sixteen inches, a height 408 of eight inches, and a width 409 of eight inches. An alternative, smaller plastic block can be provided to replace standard bricks, having a height 408 and width 409 of 3.75 inches and a length 407 of 7.5 inches. In embodiments of the block 400 shown in FIGS. 4A-4D, the block 400 has an open bottom 403, with the female locking members 404 arranged therein. The block has an outer wall 405 around the open bottom 502, and a central wall 406 in between the female locking members 404. The central wall 406 may have a thickness that is double the thickness of the outer wall 405. Although the Figures show the male locking members 402 on the top surface 401 and the female locking members 404 on the bottom surface 403, the arrangement can be reversed in other embodiments. The block 400 may also be provided in different sizes or shapes than those shown in the Figures.

Plastic shingles can also be created for use in building construction, which can be used to replace shingles made from alternate materials such as asphalt, slate, wood, ceramic, metal, wood, clay, or concrete. The plastic shingles may also incorporate interlocking elements, similar to what is shown in FIG. 4, to connect various shingles. Plastic siding can also be created for use in building construction, which can be used to replace siding made from alternate materials such as wood, metal, aluminum, steel, vinyl, or fiber cement. The plastic siding may also incorporate interlocking elements, similar to what is shown in FIG. 4, to connect siding elements. Plastic boards or planks derived from the systems discussed herein can also be used for replacing standard wooden boards used in construction. Plastic affordable housing kits can be provided, which incorporate plastic building materials as described herein, and which allow modularity and flexibility in construction.

It should be understood that, unless stated otherwise herein, any of the features, characteristics, alternatives or modifications described regarding a particular embodiment herein may also be applied, used, or incorporated with any other embodiment described herein. Also, the Figures herein are not drawn to scale. Although the invention has been described and illustrated with respect to exemplary embodiments thereof, the foregoing and various other additions and omissions may be made therein and thereto without departing from the spirit and scope of the present invention.

1. A method comprising:
providing recovered plastic waste from a waste repository;
combusting biomass waste by a combustion system to generate residual heat and heated exhaust; and
using the residual heat and heated exhaust in manufacturing new plastic products from the recovered plastic waste.

2. The method according to claim 1, wherein the waste repository is a landfill, and wherein the method further comprises:
sorting waste recovered from the landfill into the recovered plastic waste, the biomass waste, and metals, wherein the biomass waste recovered from the landfill is provided to the combustion system.

3. The method according to claim 2, further comprising:
providing recovered plastic waste to a pre-manufacturing processing stage, the pre-manufacturing processing stage comprising one or more of:
sorting the recovered plastic waste and removing items of plastic waste not to be used in the new plastic products;
decontaminating the recovered plastic waste; and/or
cutting the recovered plastic waste; and
outputting processed plastic waste to a plastic product manufacturing stage.

4. The method according to claim 1, further comprising a plastic product manufacturing stage comprising:
combusting the biomass waste by the combustion system to generate the residual heat and heated exhaust;
using the residual heat and heated exhaust to melt the recovered plastic waste to generate melted plastic; and
providing the melted plastic to a mold to shape and form a new plastic product.

5. The method according to claim 3, wherein the plastic product manufacturing stage comprises:
combusting the biomass waste by the combustion system to generate the residual heat and heated exhaust;
using the residual heat and heated exhaust to melt the processed plastic waste to generate melted plastic; and
providing the melted plastic to a mold to shape and form a new plastic product.

6. The method according to claim 1, further comprising a plastic product manufacturing stage comprising:
combusting the biomass waste by the combustion system to generate the residual heat and heated exhaust;
providing the recovered plastic waste to a mold configured to melt plastic to shape and form a new plastic product; and
using the residual heat and heated exhaust by the mold in forming the new plastic product.

7. The method according to claim 3, wherein the plastic product manufacturing stage comprises:
combusting the biomass waste by the combustion system to generate the residual heat and heated exhaust;
providing the processed plastic waste to a mold configured to melt plastic to shape and form a new plastic product; and
using the residual heat and heated exhaust by the mold in forming the new plastic product.

8. The method according to claim 1, further comprising a plastic product manufacturing stage comprising:
combusting the biomass waste by the combustion system to generate the residual heat and heated exhaust;
providing the recovered plastic waste to a press configured to fuse plastic to shape and form a new plastic product; and
using the residual heat and heated exhaust by the press in forming the new plastic product.

9. The method according to claim 3, wherein the plastic product manufacturing stage comprises:
combusting the biomass waste by the combustion system to generate the residual heat and heated exhaust;
providing the processed plastic waste to a press configured to fuse plastic to shape and form a new plastic product; and
using the residual heat and heated exhaust by the press in forming the new plastic product.

10. The method according to claim 1, further comprising:
providing at least a portion of the residual heat and heated exhaust from the combustion system to an electricity generating system comprising electric turbines;
generating electricity by the electric turbines using the residual heat and heated exhaust from the combustion system;
supplying the electricity to the plastic product manufacturing stage; and
outputting turbine exhaust and turbine heat to the plastic product manufacturing stage for use therein.

11. The method according to claim 1, further comprising:
recovering methane from the waste repository;
providing the methane to a second combustion system configured to burn methane to generate additional residual heat and additional heated exhaust; and
outputting the additional residual heat and additional heated exhaust to the plastic product manufacturing stage for use therein.

12. The method according to claim 1, further comprising:
recovering methane from the waste repository;
providing the methane to an electricity generating system configured to burn methane to power turbines to generate electricity, additional residual heat and additional heated exhaust; and
outputting the electricity, additional residual heat and additional heated exhaust to the plastic product manufacturing stage for use therein.

13. The method according to claim 1, wherein the new plastic products comprise construction products, including blocks comprising male locking members on a first surface, and female locking members on an opposing surface, the male locking members configured to engage the female locking members to allow blocks to be stacked.

14. A system comprising:
a waste repository comprising plastic waste and biomass waste and a sorting station configured for sorting recovered plastic waste and recovered biomass waste from other waste in the waste repository;
a combustion system configured to combust separated biomass waste to generate residual heat and heated exhaust; and
a plastic product manufacturing system configured to use the residual heat and heated exhaust in manufacturing new plastic products from recovered plastic waste from the waste repository.

15. The system according to claim 14, further comprising:
a pre-manufacturing processing system, the pre-manufacturing processing system configured to perform one or more of sorting the recovered plastic waste and removing items of plastic waste not to be used in the new plastic products, decontaminating the recovered plastic waste, and/or cutting the recovered plastic waste; and
the pre-manufacturing processing system being further configured to output processed plastic waste to a plastic product manufacturing stage.

16. The system according to claim 15, wherein the plastic product manufacturing system comprises:
the combustion system configured to combust the biomass waste and to generate the residual heat and heated exhaust;
a plastic melting device configured to use the residual heat and heated exhaust to melt the processed plastic waste to generate melted plastic; and
a mold configured to shape and form the melted plastic into a new plastic product.

17. The system according to claim 15, wherein the plastic product manufacturing system comprises:
the combustion system configured to combust the biomass waste and to generate the residual heat and heated exhaust; and
a mold configured to melt the processed plastic waste to shape and form a new plastic product using the residual heat and heated exhaust in forming the new plastic product.

18. The system according to claim 15, wherein the plastic product manufacturing system comprises:
the combustion system configured to combust the biomass waste and to generate the residual heat and heated exhaust; and
a press configured to fuse the processed plastic waste to shape and form the new plastic product.

19. The system according to claim 14, further comprising an electricity generating system comprising electric turbines configured to:
receive at least a portion of the residual heat and heated exhaust from the combustion system;
generate electricity by the electric turbines using the residual heat and heated exhaust from the combustion system;
supply the electricity to the plastic product manufacturing system; and
output turbine exhaust and turbine heat to the plastic product manufacturing system for use therein.

20. The system according to claim 14, further comprising
a second combustion system configured to burn methane recovered from the waste repository to generate additional residual heat and additional heated exhaust, and to output the additional residual heat and additional heated exhaust to the plastic product manufacturing system for use therein.

21. The system according to claim 14, further comprising
an electricity generating system comprising electric turbines; and
a second combustion system configured to burn methane recovered from the waste repository to generate additional residual heat and additional heated exhaust,
wherein the electricity generating system is configured to receive at least a portion of the additional residual heat and additional heated exhaust from the second combustion system, generate electricity by the electric turbines using the additional residual heat and additional heated exhaust from the combustion system; supply the electricity to the plastic product manufacturing system; and output turbine exhaust and turbine heat to the plastic product manufacturing system for use therein.
